(19) United States
(12) Patent Application Publication
(10) Pub. No.: US 2026/0326247 A1
(43) Pub. Date: Oct. 22, 2026

(54) System and Method for Deconstructing Pocket Coils

(71) Applicant: Innovated Heat Solutions LLC, Upland, CA (US)

(72) Inventors: Jon Nasser, Manhattan Beach, CA (US); Britt Lee Wilson, Somers, MT (US); Juan Jose Segura, Brentwood, CA (US); Guadalupe Arias, Modesto, CA (US)

(21) Appl. No.: 19/649,195

(22) Filed: Apr. 16, 2026

Related U.S. Application Data
(60) Provisional application No. 63/789,648, filed on Apr. 16, 2025.

(51) Int. Cl. B23P 19/04

(52) U.S. Cl. CPC B23P 19/048

(57) ABSTRACT

Systems and methods for deconstructing pocket coils are provided. A method includes heating at least one pocket coil until at least one spring of the at least one pocket coil is exposed and extracting the at least one spring from the at least one pocket coil after the at least one spring is exposed.

### CROSS-REFERENCE TO RELATED APPLICATION

This application claims the benefit of U.S. Provisional Patent Application No. 63/789,648, filed on Apr. 16, 2025, the disclosure of which is hereby incorporated by reference in its entirety.

### BACKGROUND

### 1. Technical Field

This disclosure relates generally to systems and methods for deconstructing pocket coils from mattresses.

### 2. Technical Considerations

When recycling mattresses, deconstructing pocket coils (i.e., springs at least partially encased in a material covering) presents technical difficulties. The design of a pocket coil makes it difficult to separate the material covering from the spring without expending additional labor and time. Existing methods to recycle and/or process pocket coils involve grinding the pocket coils with sharp tools, which does not result in usable parts and requires expensive machinery. Recyclers may require the material and springs to be separated.

### SUMMARY

According to non-limiting embodiments or aspects, provided is a method comprising: heating at least one pocket coil until at least one spring of the at least one pocket coil is exposed; and extracting the at least one spring from the at least one pocket coil after the at least one spring is exposed.

In non-limiting embodiments or aspects, heating the at least one pocket coil comprises exposing the at least one pocket coil to a temperature of 600-800 degrees Fahrenheit. In non-limiting embodiments or aspects, exposing the at least one pocket coil to the temperature comprises arranging at least one heat lamp configured to heat the at least one pocket coil. In non-limiting embodiments or aspects, the method further includes: after the at least one spring is exposed, compressing the at least one pocket coil; and decompressing the at least one pocket coil before extracting the at least one spring. In non-limiting embodiments or aspects, the at least one pocket coil comprises a plurality of pocket coils arranged in a mattress, the method further includes: conveying at least a portion of mattress including the plurality of pocket coils to a heated region for heating the plurality of pocket coils. In non-limiting embodiments or aspects, extracting the at least one spring comprises: extracting at least one spring from at least one fabric covering of the at least one pocket coil with a first pinch roller; and extracting the at least one fabric covering with a second pinch roller after extracting the at least one spring.

According to non-limiting embodiments or aspects, provided is a system comprising: a conveyor; a heater arranged with respect to the conveyor and configured to heat objects conveyed by the conveyor; and an extraction device arranged with respect to the conveyor and configured to extract at least one spring from at least one pocket coil of a mattress being conveyed by the conveyor after the at least one pocket coil is heated by the heater.

In non-limiting embodiments or aspects, the system further includes: a compression mechanism arranged with respect to the conveyor and configured to compress at least one pocket coil of a mattress being conveyed by the conveyor after the at least one pocket coil is heated by the heating device and before the extraction device extracts the at least one spring. In non-limiting embodiments or aspects, the extraction device comprises a pinch roller. In non-limiting embodiments or aspects, the system further includes: a pinch roller configured to extract a plurality of springs from a plurality of fabric coverings, including the at least one spring, after the pocket coils are heated by the heating device. In non-limiting embodiments or aspects, the extraction device comprises a second pinch roller configured to extract the plurality of fabric coverings after the pinch roller extracts the plurality of springs. In non-limiting embodiments or aspects, the heater comprises at least one heat lamp. In non-limiting embodiments or aspects, the heater is configured to heat the objects to a temperature of 600-800 degrees Fahrenheit. In non-limiting embodiments or aspects, the system further includes a controller configured to control the conveyor and the heater.

According to non-limiting embodiments or aspects, provided is a pocket coil processing apparatus comprising: at least one heater; at least one spring extraction device; and at least one pocket coil cover extraction device. In non-limiting embodiments or aspects, further comprising at least one compression device. In non-limiting embodiments or aspects, further comprising a conveyor configured to convey at least one object through a region heated by the at least one heater and to the at least one spring extraction device and the at least one pocket coil cover extraction device.

These and other features and characteristics of the present disclosure, as well as the methods of operation and functions of the related elements of structures and the combination of parts and economies of manufacture, will become more apparent upon consideration of the following description and the appended claims with reference to the accompanying drawings and appendix, all of which form a part of this specification, wherein like reference numerals designate corresponding parts in the various figures. It is to be expressly understood, however, that the drawings and appendix are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for deconstructing pocket coils according to some non-limiting embodiments or aspects;

FIG. 2 is a further schematic diagram of a system for deconstructing pocket coils according to some non-limiting embodiments or aspects;

FIG. 3 is a schematic diagram of example components of one or more devices of FIGS. 1 and 3, according to some non-limiting embodiments or aspects;

FIG. 4 is a flow diagram of a method of deconstructing pocket coils according to some non-limiting embodiments or aspects;

FIG. 5 is a flow diagram of a method of deconstructing pocket coils according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting. Moreover, other than in any operating examples, or where otherwise indicated, all numbers expressing, for example, parameters used in the specification and claims are to be understood as being modified in all instances by the term “about”. Accordingly, unless indicated to the contrary, the numerical parameters set forth in the following specification and attached claims are approximations that may vary depending upon the desired properties to be obtained.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may include one or more processors, such as microprocessors, central processing units (CPUs), graphics processing units (GPUs), and/or the like.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments provide for a method for deconstructing pocket coils from mattresses, including separating material coverings from springs, in an efficient and cost-effective manner that enables retention of the materials (e.g., metal, fabric, and/or the like). Pocket coils may have a level of compression for mattress firmness, where a spring inside of a material covering (such as cloth) is partially compressed.

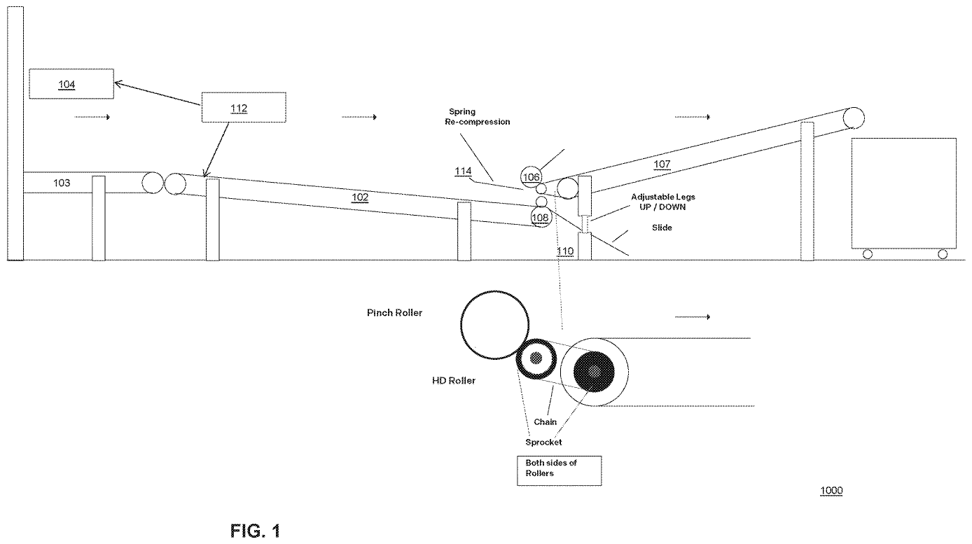

Referring now to FIG. 1, shown is a system 1000 for deconstructing pocket coils according to non-limiting embodiments or aspects. The system includes conveyors 102, 103 configured to convey a mattress or portion thereof (e.g., a partially deconstructed mattress). A first conveyor 103 may convey the mattress under a heater 104 arranged with respect to the conveyor 103 to provide radiant heat to the mattress or portion thereof as it is conveyed. In operation, the heater 104 causes the springs within the pocket coils to expand and to pop out from the covering material. A controller 112, which may include one or more computing devices, is in communication with at least the heater 104 and the conveyors 102, 103, 107 to control operation. It will be appreciated that one or more computing devices may control one or more elements of the system 1000.

In non-limiting embodiments, the controller 112 may be used to regulate the time and temperature of the heat exposure provided by the heater 104. For example, the controller 112 may adjust the time and/or temperature for different types of fabrics (e.g., material coverings), different types of springs, different types of mattresses, and/or the like. In non-limiting embodiments, the pocket coils may be exposed to the heat for approximately two minutes. In non-limiting embodiments, the pocket coils may be exposed to the heat for less than one minute. In non-limiting embodiments, the pocket coils may be exposed to the heat for thirty seconds or less. In non-limiting embodiments, the heater 104 may be controlled and/or arranged (e.g., spaced from the mattress) to heat the pocket coils to a temperature range of about 600-800 degrees Fahrenheit. It will be appreciated that various other times and temperatures may be used in non-limiting embodiments.

With continued reference to FIG. 1, after the pocket coils are exposed to heat, the mattress or portion thereof with exposed springs is conveyed toward an extraction device configured to extract the springs from the material coverings and then extract the material coverings from the mattress or portion thereof. In some non-limiting embodiments, the mattress or portion thereof may be recompressed by a compression plate 114 or other like device, which may compress the mattress or portion thereof and then decompress the same before being subjected to the extraction device. Such compression and decompression may further separate the material coverings and/or springs for extraction. In some examples, the compression plate 114 may maintain the pocket coils in a compressed state until being engaged by the first pinch roller 106.

The extraction device may include a first pinch roller 106 as shown in FIG. 1. In this example configuration, the first pinch roller 106 removes the exposed springs from the material coverings by grasping them, resulting in the springs being conveyed by conveyor 107 to a hopper or shredder. It will be appreciated that the extraction device may include any other type of device or system for extracting the springs, such as a brushing machine that sweeps the springs, a roller, a robotic arm, and/or the like.

The extraction device may also include a second pinch roller 108 arranged to remove the material coverings after the springs have been removed. For example, the leading edge of the cloth may be captured by the pinch roller 108 such that the material coverings are extracted and transported down the slide. Adjustable supports 110 may be used to adjust the height of the pinch roller(s) based on a thickness of the mattress and/or other variations.

In non-limiting embodiments, a shredding device may be used to break the coils into smaller pieces and separate the remaining cloth from the metal. The shredding may be performed additionally or alternatively to extracting the coils and/or using the second pinch roller 108. For example, instead of extracting the coils after exposing the covered coils to heat, the coils may still have material coverings attached at least partially to the coils and can be fed into a shredder machine to be processed into smaller pieces, such that any material coverings are more likely to separate from the coils. The shredding may occur after processing the mattress with the first pinch roller 106 or, alternatively, may occur instead of processing the mattress with the first pinch roller.

In non-limiting embodiments, the system 1000 may include an air filtration system to filter and/or remove any toxins, such as chemical vapors produced from the heating process. The filter may be arranged with respect to the heater 104.

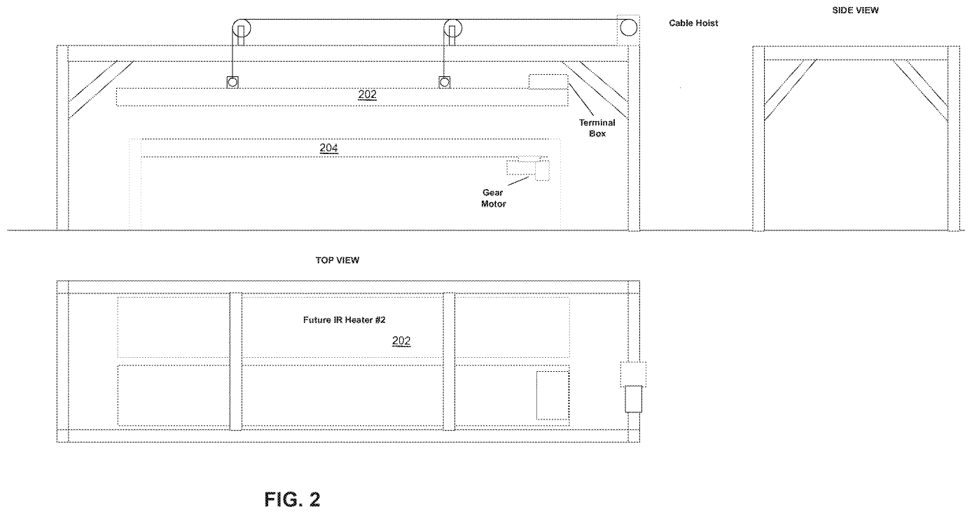

Referring now to FIG. 2, shown is a system for deconstructing pocket coils according to non-limiting embodiments or aspects. In the front view, the conveyor 204 (e.g., conveyor 103 from FIG. 1) is shown positioned below the heater 202. The heater 202 is suspended with cables from a structure such as a truss and/or frame. It will be appreciated that other arrangements are possible in accordance with non-limiting embodiments. In non-limiting embodiments, the heater 202 may include heat lamps arranged in a housing with an exhaust (e.g., such as an exhaust hood) to remove chemicals, debris, and/or fumes produced from the heat. The housing may include sidewalls to focus and/or enclose the heat for efficiency and/or safety. The dimensions and measurements shown in FIG. 2 are for example purposes only.

The number and arrangement of systems and devices shown in FIGS. 1 and 2 are provided as an example. There may be additional systems and/or devices, fewer systems and/or devices, different systems and/or devices, and/or differently arranged systems and/or devices than those shown in FIGS. 1 and 2.

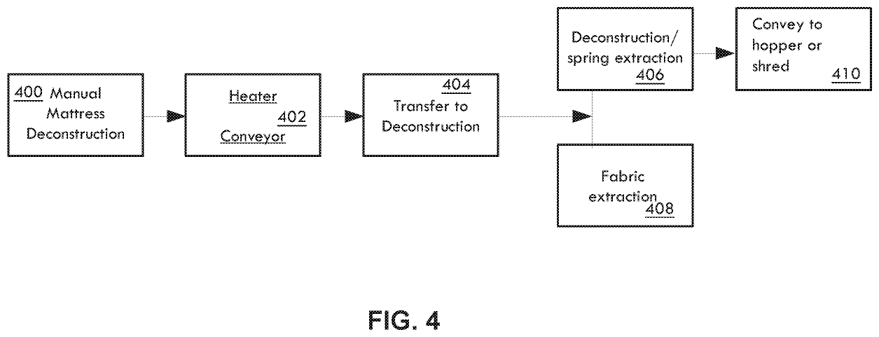

FIG. 4 illustrates a flow diagram of a method of deconstructing pocket coils according to some non-limiting embodiments or aspects. The steps shown in FIG. 4 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

At step 400, a manual mattress deconstruction process may be performed. For example, a mattress may be partially deconstructed by removing a top and/or bottom of a mattress using a machine to cut the top off laterally. It will be appreciated that various machines and/or methods may be used to partially deconstruct the mattress to expose the covered coils by removing one or more first layers (e.g., cushion layers, foam layers, surface layers, and/or the like). At step 402, the partially deconstructed mattress is conveyed to a heating device where it is exposed to heat as explained herein to partially remove the coils from the material coverings. At step 404, the mattress with exposed coils (e.g., coils that have extended and broken through the material coverings) is transferred via conveyor or otherwise to a deconstruction phase.

With continued reference to FIG. 4, a deconstruction phase may involve extracting the coils via one or more machines as described herein. In some non-limiting embodiments, at step 406 the coils may be extracted with one or more extraction devices (e.g., rollers described here) and/or conveyed to a shredding device. For example, in some non-limiting embodiments the coils may be extracted from the remaining mattress materials but still include some material coverings attached to the coils. The coils with material still attached may be processed by a shredding machine, which effectively extracts the remaining fabric by breaking up the coil and material coverings into small pieces such that the material pieces fall away loose from the coil pieces. In some non-limiting embodiments where shredding is not performed, a first pinch roller may be used at step 406 to remove the coils and remaining material coverings still attached, and a second pinch roller may be used at step 408 to remove the remaining material coverings. In some non-limiting embodiments, step 406 may include using a mechanical roller and/or brush device to separate the coils from the remaining materials. At step 410, the clean coils may be sent to a hopper for collection or to a shredder for shredding.

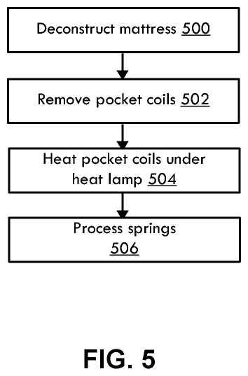

FIG. 5 illustrates a flow diagram of a method of deconstructing pocket coils according to some non-limiting embodiments or aspects. The steps shown in FIG. 5 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. At step 500, a mattress is deconstructed. For example, the top of the mattress may be removed. At step 502, pocket coils are removed from the mattress. The pocket coils may be in strips in some examples. The pocket coils may be removed automatically with a machine, such as a roller device, or may be manually removed by a person or robot. The removed pocket coils are placed on a conveyor belt. At step 504, the pocket coils on the conveyor belt are heated until the material (e.g., fabric) coverings melt off and/or the springs within the pocket coils extend from the heat and tear apart the fabric coverings. At step 506 the springs may be processed without the material coverings by, for example, shredding only the springs and/or recycling the springs.

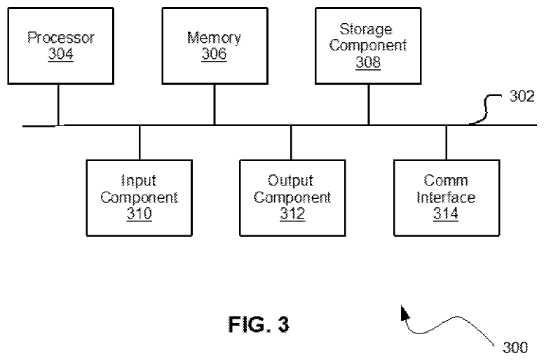

Referring now to FIG. 3, shown is a diagram of example components of a device 300 according to non-limiting embodiments. Device 300 may correspond to controller 112, as an example. In some non-limiting embodiments, such systems or devices may include at least one device 300 and/or at least one component of device 300. The number and arrangement of components shown are provided as an example. In some non-limiting embodiments, device 300 may include additional components, fewer components, different components, or differently arranged components than those shown. Additionally, or alternatively, a set of components (e.g., one or more components) of device 300 may perform one or more functions described as being performed by another set of components of device 300.

As shown in FIG. 3, device 300 may include a bus 302, a processor 304, memory 306, a storage component 308, an input component 310, an output component 312, and a communication interface 314. Bus 302 may include a component that permits communication among the components of device 300. In some non-limiting embodiments, processor 304 may be implemented in hardware, firmware, or a combination of hardware and software. For example, processor 304 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 306 may include random access memory (RAM), read only memory (ROM), and/or another type of dynamic or static storage device (e.g., flash memory, magnetic memory, optical memory, etc.) that stores information and/or instructions for use by processor 304.

With continued reference to FIG. 3, storage component 308 may store information and/or software related to the operation and use of device 300. For example, storage component 308 may include a hard disk (e.g., a magnetic disk, an optical disk, a magneto-optic disk, a solid-state disk, etc.) and/or another type of computer-readable medium. Input component 310 may include a component that permits device 300 to receive information, such as via user input (e.g., a touch screen display, a keyboard, a keypad, a mouse, a button, a switch, a microphone, etc.). Additionally, or alternatively, input component 310 may include a sensor for sensing information (e.g., a global positioning system (GPS) component, an accelerometer, a gyroscope, an actuator, etc.). Output component 312 may include a component that provides output information from device 300 (e.g., a display, a speaker, one or more light-emitting diodes (LEDs), etc.). Communication interface 314 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 314 may permit device 300 to receive information from another device and/or provide information to another device. For example, communication interface 314 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 300 may perform one or more processes described herein. Device 300 may perform these processes based on processor 304 executing software instructions stored by a computer-readable medium, such as memory 306 and/or storage component 308. A computer-readable medium may include any non-transitory memory device. A memory device includes memory space located inside of a single physical storage device or memory space spread across multiple physical storage devices. Software instructions may be read into memory 306 and/or storage component 308 from another computer-readable medium or from another device via communication interface 314. When executed, software instructions stored in memory 306 and/or storage component 308 may cause processor 304 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A method comprising:
heating at least one pocket coil until at least one spring of the at least one pocket coil is exposed; and
extracting the at least one spring from the at least one pocket coil after the at least one spring is exposed.

2. The method of claim 1, wherein heating the at least one pocket coil comprises exposing the at least one pocket coil to a temperature of 600-800 degrees Fahrenheit.

3. The method of claim 1, wherein exposing the at least one pocket coil to the temperature comprises arranging at least one heat lamp configured to heat the at least one pocket coil.

4. The method of claim 1, further comprising:
after the at least one spring is exposed, compressing the at least one pocket coil; and
decompressing the at least one pocket coil before extracting the at least one spring.

5. The method of claim 1, wherein the at least one pocket coil comprises a plurality of pocket coils arranged in a mattress, further comprising:
conveying at least a portion of mattress including the plurality of pocket coils to a heated region for heating the plurality of pocket coils.

6. The method of claim 1, wherein extracting the at least one spring comprises:
extracting the at least one spring from at least one fabric covering of the at least one pocket coil with a first pinch roller; and
extracting the at least one fabric covering with a second pinch roller after extracting the at least one spring.

7. The method of claim 1, further comprising:
shredding the at least one spring and at least one fabric covering of the at least one pocket coil; and
separating pieces of the at least one spring and the at least one fabric covering after shredding.

8. A system comprising:
a conveyor;
a heater arranged with respect to the conveyor and configured to heat objects conveyed by the conveyor; and
an extraction device arranged with respect to the conveyor and configured to extract at least one spring from at least one pocket coil of a mattress being conveyed by the conveyor after the at least one pocket coil is heated by the heater.

9. The system of claim 8, further comprising:
a compression mechanism arranged with respect to the conveyor and configured to compress at least one pocket coil of a mattress being conveyed by the conveyor after the at least one pocket coil is heated by the heating device and before the extraction device extracts the at least one spring.

10. The system of claim 8, wherein the extraction device comprises a pinch roller.

11. The system of claim 8, further comprising:
a pinch roller configured to extract a plurality of springs from a plurality of fabric coverings, including the at least one spring, after the pocket coils are heated by the heating device.

12. The system of claim 11, wherein the extraction devices comprises a second pinch roller configured to extract the plurality of fabric coverings after the pinch roller extracts the plurality of springs.

13. The system of claim 8, wherein the heater comprises at least one heat lamp.

14. The system of claim 8, wherein the heater is configured to heat the objects to a temperature of 600-800 degrees Fahrenheit.

15. The system of claim 8, further comprising a controller configured to control the conveyor and the heater.

16. A pocket coil processing apparatus comprising:
at least one heater;
at least one spring extraction device; and
at least one shredding machine.

17. The pocket coil processing apparatus of claim 16, further comprising at least one compression device.

18. The pocket coil processing apparatus of claim 16, further comprising a conveyor configured to convey at least one object through a region heated by the at least one heater and to the at least one spring extraction device and the at least one shredding machine.

19. The pocket coil processing apparatus of claim 16, further comprising a conveyor configured to convey at least one object through a region heated by the at least one heater and to the at least one spring extraction device and at least one pocket coil cover extraction device.
